(19) United States
(12) Patent Application Publication
(10) Pub. No.: US 2016/0275632 A1
(43) Pub. Date: Sep. 22, 2016

(54) METHOD OF RECOMMENDING GAS STATION ASSOCIATED WITH PAYMENT APPLICATION AND DEVICE USING THE METHOD

(71) Applicant: SK Planet Co., Ltd., Gyeonggi-do (KR)

(72) Inventor: Jongwon WOO, Incheon (KR)

(73) Assignee: SK Planet Co., Ltd., Gyeonggi-do (KR)

(21) Appl. No.: 14/951,247

(22) Filed: Nov. 24, 2015

(30) Foreign Application Priority Data
Mar. 18, 2015 (KR) 10-2015-0037307

(51) Int. Cl. G06Q 50/14; G01C 21/34; G06Q 30/06

(52) U.S. Cl. CPC G06Q 50/14; G06Q 30/0631; G06Q 30/0639; G01C 21/3469

(57) ABSTRACT

The present invention relates to a method of recommending a gas station, and more particularly, to a method and device of recommending a gas station associated with a payment application which is able to manage information on the current amount of fuel in the vehicle, recommend an optimum gas station associated with the payment application when it is determined that fueling is needed, and guide a user to the optimum gas station. The method of recommending a gas station associated with a payment application includes receiving, by a service server, destination information from a terminal; calculating, by the service server, an amount of necessary fuel based on the destination information and vehicle information for the terminal; comparing, by the service server, an amount of remaining fuel for the terminal and the calculated amount of necessary fuel to determine whether fueling is needed; when the fueling is needed, extracting, by the service server, information on a recommended gas station from information on gas stations located on a moving route to a destination based on payment-related information for the terminal; and providing, by the service server, the extracted information on the recommended gas station to the terminal.

### CROSS-REFERENCE TO RELATED APPLICATION

This application claims priority to and the benefit of Korean Patent Application No. 10-2015-0037307 filed in the Korean Intellectual Property Office on Mar. 18, 2015, the entire contents of which are incorporated herein by reference.

### TECHNICAL FIELD

The present invention relates to a method of recommending a gas station, and more particularly, to a method of recommending a gas station associated with a payment application, which is able to manage information on a current amount of fuel in a vehicle, recommend an optimum gas station associated with the payment application when it is determined that fueling is needed, and guide a user to the optimum gas station, and a device using the method.

### BACKGROUND

The content described in this part only provides back ground information on embodiments of the present invention, but it does not form a related art.

Recently, car navigation systems which provide various conveniences to the car have been widely used. The navigation system is a system in which position information provided by global positioning system (GPS) satellites is used in a car, and map information of a surrounding area is provided to a driver based on information on a current location of the car. That is, the navigation system detects current location information on the car using GPS information received from GPS satellites, and provides the path to a destination based on the detected information on the current location information on the car.

The current navigation system only calculates an optimum moving route and provides the optimum moving route to the user, and it cannot determine when a supply of fuel is needed and it cannot provide the gas station which has the lowest gas price when the fuel is supplied.

Therefore, it is required to develop a method of providing information on the gas station located on the moving route when the supply of fuel is needed on driving.

### PRIOR ART DOCUMENT

### Patent Document

Korean Patent Application Publication No. 2009-0027830 published on Mar. 18, 2009, entitled “Fueling System based on RFID System and Method of Operating the Same”

### SUMMARY

The present invention is directed to providing a method of recommending a gas station associated with a payment application and a device using the method. The method may manage an amount of fueling in a vehicle associated with the payment application, and when the fueling is needed, may recommend an optimum gas station associated with the payment application and guide a user to the optimum gas station.

The present invention is also directed to providing a method of recommending a gas station associated with a payment application, which can recommend an optimum gas station in consideration of payment-related information including usage results of a card and a benefit of user cards registered in a payment application, and a device using the method.

However, the objectives of the present invention are not to be limited by the above-described objectives, and other objectives which are not mentioned will be clearly understood by the following descriptions.

According to one aspect of the present invention, a method of recommending a gas station associated with a payment application may include receiving, by a service server, destination information from a terminal; calculating, by the service server, an amount of necessary fuel based on the destination information and vehicle information for the terminal; comparing, by the service server, an amount of remaining fuel for the terminal and the calculated amount of necessary fuel to determine whether fueling is needed; when the fueling is needed, extracting, by the service server, information on a recommended gas station from information on gas stations which are located on a moving route to a destination based on payment-related information for the terminal; and providing, by the service server, the extracted information on the recommended gas station to the terminal.

Before receiving the destination information, the method may further include receiving and storing, by the service server, the vehicle information and information on the amount of remaining fuel from the terminal.

Further, after storing the vehicle information and the information on the amount of remaining fuel, the method may further include receiving, by the service server, information on an amount of fuel to be consumed based on a moving distance from start to stop from the terminal; and correcting, by the service server, the remaining amount of fuel based on the information on the amount of fuel to be consumed.

Further, after storing the vehicle information and the information on the amount of remaining fuel, the method may further include receiving, by the service server, fueling information generated after payment using the fueling payment application from the terminal; and correcting the amount of remaining fuel based on the fueling information.

Further, the extracting of the information on the recommended gas station may include requesting, by the service server, the payment application of the terminal for payment-related information including information on a service membership card of the terminal to obtain the payment-related information; and after checking, by the service server, the information on a service membership card of the terminal, extracting information on a gas station having a highest discount rate from information on gas stations located on the moving route based on the information on the service membership card of the terminal as the recommended gas station, or extracting information on a certain gas station as information on the recommended gas station in consideration of a usage pattern of the service membership card of the terminal by the service server.

Further, when a gas station which provides a service benefit based on the information on the service membership card of the terminal does not exist among gas stations located on the moving route, the method may further include extracting, by the service server, information on the recommended gas station from information on gas stations located within a certain radius of the moving route; and correcting, by the service server, the moving route to move to the recommended gas station, and guiding the terminal thereto.

Further, after providing the extracted information on the recommended gas station, when fueling information is not received through the payment application from the terminal, the method may further include exhibiting, by the service server, a message for inputting the amount of remaining fuel to the terminal.

In addition, the present invention may provide the computer-readable medium in which a program which executes the method of recommending a gas station associated with a payment application is written.

According to another aspect of the present invention, a service server may include an information obtaining module configured to receive and obtain destination information, vehicle information and information on an amount of remaining fuel from a terminal; a remaining fuel amount calculating module configured to correct and calculate the amount of remaining fuel based on fueling information generated by a payment application of the terminal; a necessary fuel amount calculating module configured to calculate the amount of necessary fuel based on the destination information and the vehicle information; and a service processing module configured to compare the amount of remaining fuel for the terminal and the calculated amount of necessary fuel to determine whether fueling is needed, and when the fueling is needed, configured to extract information on a recommended gas station from information on gas stations located on a moving route to a destination based on a payment-related information for the terminal.

The service server may further include a search supporting module configured to transmit information on the recommended gas station to the terminal.

According to embodiments of the present invention, a method and a device of recommending a gas station associated with a payment application can determine more exactly when the fueling is needed, and can more easily check information on the amount of fuel associated with the payment application even when a separate device for checking the amount of fuel is not included.

Further, according to embodiments of the present invention, a customized gas station recommendation can be provided in consideration of a life pattern of a user by recommending an optimum gas station in consideration of payment-related information including usage results and benefits of user cards registered in the payment application.

Further, various effects except for the effects described above can be disclosed directly or implicitly in the detailed description which will be described hereinafter according to embodiments of the present invention.

### BRIEF DESCRIPTION OF DRAWINGS

FIG. 1 is a schematic diagram illustrating a configuration of a system for recommending a gas station according to an embodiment of the present invention.

FIG. 2 is a block diagram illustrating a main configuration of a terminal according to an embodiment of the present invention.

FIG. 3 is a block diagram illustrating a main configuration of a service server according to an embodiment of the present invention.

FIG. 4 is a flowchart illustrating a method of recommending a gas station associated with a payment application according to an embodiment of the present invention.

FIGS. 5 to 7 are data flowcharts illustrating a method of recommending a gas station associated with a payment application according to an embodiment of the present invention in more detail.

FIG. 8 is a block diagram illustrating a computing system which implements the method of recommending a gas station associated with a payment application according to embodiments of the present invention.

### DETAILED DESCRIPTION

Hereinafter, exemplary embodiments of the present invention will be described in detail with reference to the accompanying drawings. The features and advantages of aspects of the present invention will become more apparent from the detailed description set forth below.

However, detailed descriptions related to well-known functions or configurations will be ruled out in order not to unnecessarily obscure the subject matter of the present invention. In addition, it should be noted that like reference numerals denote like elements throughout the specification and drawings.

The terms or words used in the following description and drawings should not be construed as being limited to typical or dictionary meanings, but should be construed as the meaning and concept corresponding to the technical idea of the present invention on the basis of the principle that an inventor can appropriately define the concept of the term for describing his or her invention in the best manner. Accordingly, the configurations illustrated in embodiments and drawings described in the specification do not represent the technical idea of the present invention but are just exemplary embodiments. Thus, it should be understood that various equivalents and modifications may exist which can be used as replacements at the time of filing an application.

While the terms including an ordinal number, such as “first,” “second,” etc. may be used herein to describe various elements, such elements are not limited by these terms. The terms are only to distinguish one component from another. For example, a first component may be named a second component without departing from the scope of the present invention and the second component may also be similarly named the first component.

It is to be understood that when one element is referred to as being “connected to” or “coupled to” another element, it may be connected or coupled logically or physically. In other words, it is to be understood that one element may be directly connected or coupled to another element or indirectly connected or coupled to another element with a third element intervening therebetween.

The terms used in the present specification are set forth to explain the embodiments of the present invention, and the scope of the present invention is not limited thereto. The singular forms ‘a,’ ‘an,’ and ‘the’ include plural reference unless the context clearly dictates otherwise. It will be further understood that the terms “include,” “comprise,” or “have” used in this specification, specify the presence of stated features, steps, operations, components, parts, or combinations thereof, but do not preclude the presence or addition of one or more other features, numerals, steps, operations, components, parts, or combinations thereof.

Further, embodiments within the scope of the present invention also include computer-readable media for carrying or storing computer-executable instructions and/or data structures. Such computer-readable media can be any available media that can be accessed by a general purpose or special purpose computer system. Thus, by way of example, and not limited to, the computer-readable media can include physical computer-readable storage media including RAM, ROM, EEPROM, CD-ROM or other optical disk storage, magnetic disk storage or other magnetic storage devices, or any other medium which can be used to store or deliver desired program code means in the form of computer-executable instructions, computer-readable instructions, or data structures and which can be accessed by a general purpose or special purpose computer.

In the following description and claims, the term “network” is defined as one or more data links that allow electronic data to be transmitted between computer systems and/or modules. When information is transferred or provided over a network or another communications connection (either hardwired, wireless, or a combination of hardwired or wireless) to a computer system, the computer system properly views the connection as a computer-readable medium. The computer-readable instructions include, for example, instructions and data which cause a general purpose computer system or special purpose computer system to perform a certain function or group of functions. The computer-executable instructions may be, for example, binaries, intermediate format instructions such as an assembly language, or even source code.

Furthermore, those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Hereinafter, a method of recommending a gas station associated with a payment application and a device using the method will be described with reference to the drawings in detail.

First, a system for recommending a gas station according to embodiments of the present invention will be described.

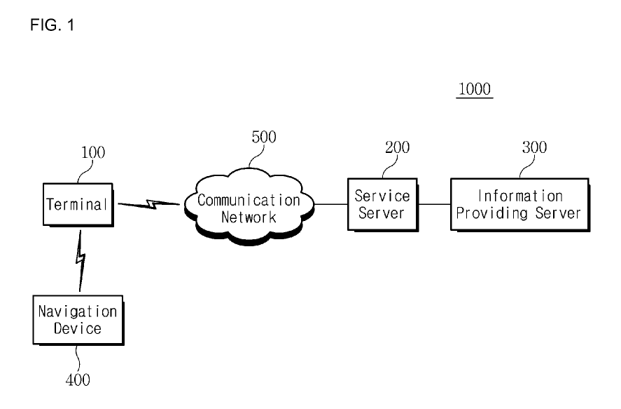

FIG. 1 is a schematic diagram illustrating a configuration of a system for recommending a gas station according to an embodiment of the present invention.

Referring to FIG. 1, the system 1000 for recommending the gas station according to the embodiment of the present invention may include a terminal 100 and a service server 200. The system 1000 may further include an information providing server 300 which provides information on gas prices, locations of various gas stations, information on other prices, etc. in association with the service server 200. The system 1000 may further include a communication network 500 which supports transmission or reception of information between various devices.

In a description outlining each of the respective elements, first, the terminal 100 may refer to a device of a user which may transmit or receive various types of data through the communication network 500 according to a user control. The terminal 100 may perform voice communication or data communication through the communication network 500, and may transmit or receive various pieces of information to or from the service server 200. To this end, the terminal 100 according to the embodiment may include a browser for transmitting or receiving information, a memory for storing programs and protocols, a microprocessor for operations and control by executing various programs.

Particularly, the terminal 100 according to the embodiment may receive a service of recommendation of a gas station provided by the service server 200 using payment-related information generated by a payment application when the payment application is in the terminal 100. Further, the terminal 100 transmits or receives information to or from a navigation device 400 within a certain radius, and may receive various pieces of information from the navigation device 400 and may serve to transfer the various pieces of information to the service server 200. The terminal 100 according to the embodiment may perform near field communication (NFC) with the navigation device 400 and a long-range wireless communication with the service server 200. However, the terminal 100 according to the embodiment may transmit or receive information with various types of communication methods.

When vehicle information and information on an amount of remaining fuel are input through a payment application by a user, the terminal 100 according to the embodiment may transfer the vehicle information and the information on the amount of remaining fuel to the service server 200. When destination information is transferred from the navigation device 400, the terminal 100 according to the embodiment may transfer the destination information to the service server 200. The terminal 100 according to the embodiment may support a whole process of receiving and outputting information on a recommended gas station extracted using payment-related information from the service server 200.

The detailed method of operating the terminal 100 will be described below, and the terminal 100 according to the embodiment may be implemented in various forms. For example, the terminal 100 according to the embodiment may include not only a mobile terminal such as a smart phone, a tablet personal computer (tablet PC), a personal digital assistant (PDA), a portable multimedia player (PMP), MP3 player, etc., but also include a fixed terminal such as a smart television (smart TV), a desktop computer, etc.

According to a trend of convergence, the modifications of portable devices are diversified and cannot be enumerated. However, units equivalent to the units described above may be used as the terminal 100 according to the embodiment. A device capable of transmitting or receiving information to or from the service server 200 through the communication network 500 and capable of transmitting or receiving information to or from the navigation device 400 which exists in a vehicle may be used as the terminal 100 according to the embodiment.

The service server 200 may refer to a device which supports the method of recommending a gas station associated with a payment application according to the embodiment of the present invention. Particularly, the service server 200 according to the embodiment of the present invention may receive and obtain destination information, vehicle information and information on an amount of remaining fuel from the terminal 100, correct and calculate the amount of remaining fuel based on fueling information generated by a payment application of the terminal 100, calculate the amount of necessary fuel based on the destination information and the vehicle information, compare the amount of remaining fuel for the terminal 100 and the calculated amount of necessary fuel to determine whether fueling is needed, and when the fueling is needed, extract information on a recommended gas station from information on gas stations located on a moving route to a destination based on a payment-related information for the terminal 100.

The detailed configurations and operating method of the terminal 100 and the service server 200 will be described below. The navigation device 400 according to the embodiment of the present invention may be located in the vehicle and may refer to a device which may calculate an optimum moving route and be a guide for the optimum moving route. The navigation device 400 may operate associated with a separate navigation server, or may operate using stored map information even when it may not be associated with the separate navigation server. The stored map information may be updated at a constant period. Further, the navigation device 400 according to the embodiment of the present invention may transmit or receive information to or from the terminal 100 located within a certain radius using an NFC method, such as a Bluetooth communication method, etc., and may support a process of transferring destination information input by a user to the terminal 100.

Further, although the navigation device 400 connected to the terminal 100 is described as an example, the present invention is not limited to the example, the navigation device 400 may directly transmit or receive information to or from the service server 200 when needed. For example, the navigation device 400 may directly transmit the destination information input through the navigation device 400 to the service server 200 rather than the terminal 100 receiving the destination information input through the navigation device 400 and transferring the destination information to the service server 200. The navigation device 400 may directly receive information on the recommended gas station. In this case, an association with the terminal 100 including identification information for the terminal 100 may be supported when the navigation device 400 transmits or receives information to or from the service server 200.

A processor mounted in each device according to the embodiment of the present invention may process program commands to execute the method according to the embodiment of the present invention. The processor may be a single-threaded processor in one embodiment, but in another embodiment, the processor may be a multi-threaded processor. Further, the processor may process commands stored in a memory or in a storage device.

Further, the terminal 100 and the service server 200 may transmit or receive various pieces of information to or from each other though the communication network 500, and it is preferable to use wireless communication systems such as wireless LAN (WLAN), Wi-Fi, Wibro, WiMax, High Speed Downlink Packet Access (HSDPA), etc. However, the communication network 500 is not limited to the wireless communication systems, and wired communication systems, such as Ethernet, xDSL which includes ADSL and VDSL, hybrid fiber coaxial cable (HFC), fiber to the curb (FTTC), fiber to the home (FTTH), etc., may be used.

Further, the communication network 500 according to the embodiment of the present invention, for example, may include a plurality of access networks (not shown) and a core network, and may include an external network such as an Internet network. Here, the access network is an access network which communicates with the terminal 100, and for example, the access network may be implemented using various base stations, such as a base station (BS), a base transceiver station (BTS), a NodeB, an eNodeB, etc., and a controller of the base station such as a base station controller (BSC) and a radio network controller (RNC). Further, as described above, a digital signal processor and a radio signal processor integrally implemented in the base station respectively may be divided into a digital unit (DU) and a radio unit (RU), and a plurality of RUs may be set in each of a plurality of areas, and the plurality of RUs (not shown) may be connected with a centralized DU (not shown).

Further, the core network (not shown) constituting a mobile network along with the access (not shown) network may serve to connect the access network to an external network such an Internet network (not shown).

As described above, the core network is a network system which performs main functions for mobile communication service such as mobility control and switching between the access networks (not shown), and the core network performs circuit switching or packet switching and manages and controls a packet flow in the mobile network. Further, the core network may control mobility between frequencies, and serve to manage traffic in the access network and the core network and serve to interwork another network such as the Internet network. The core network may further include a serving gateway (SGW), a PDN gateway (PGW), a mobile switching center (MSC), a home location register (HLR), a mobile mobility entity (MME), a home subscriber server (HSS), etc.

Further, the Internet network may refer to a general public communication network, that is, a public network, by which information is exchanged according to a TCP/IP protocol, and may be connected to the service server 200. The Internet network may provide information received from the service server 200 to the terminal 100 through the core network and the access network, and provide information received from the terminal 100 to the service server 200 through the access network and the core network.

Hereinafter, a main configuration and operating method of the terminal 100 according to the embodiment of the present invention will be described.

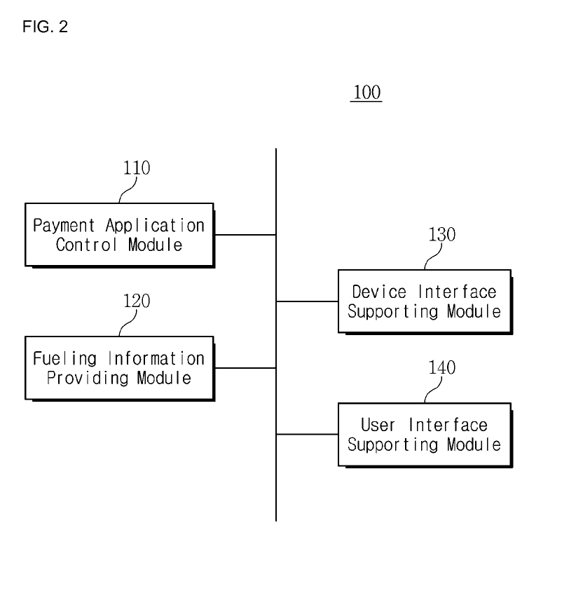

FIG. 2 is a block diagram illustrating a main configuration of a terminal according to an embodiment of the present invention.

Referring to FIGS. 1 and 2, the terminal 100 according to the embodiment of the present invention may include a payment application control module 110, a fueling information providing module 120, a device interface supporting module 130, and a user interface supporting module 140.

Here, a module is an element which performs a predetermined function, and may be implemented by hardware, software, or a combination of the hardware and the software. For example, the module may denote a program module which includes elements, such as software elements, object-oriented software elements, class elements, and task elements, and processes, functions, attributes, procedures, subroutines, segments of program code, drivers, data, database, data structures, tables, arrays, and variables. Further, functions provided in the elements and “modules” may be coupled to a small number of elements and “modules”, or may be further divided into additional elements and “modules”.

To describe modules included in the terminal 100 according to the embodiment of the present invention in more detail, first, the payment application control module 110 may refer to a module which performs general control related to execution and a control of the payment application included in the terminal 100. That is, the payment application control module 110 may refer to a module which performs various support related to the payment application such as a process of executing the payment application, a process of inputting various pieces of user card information using the payment application, and a process of processing payment information using the payment application. Further, the payment application according to the embodiment of the present invention may refer to an application which may be downloaded beforehand from the service server 200 or a separate application providing device and be installed in the terminal 100. The method of recommending a gas station associated with a payment application according to the embodiment of the present invention may be implemented through a function in the payment application. Further, the method may be implemented through an independent application which may be associated with the payment application. Hereinafter, the present invention will be described assuming that the method is implemented through a function in the payment application for convenience of description, but it should be noted that the present invention is not limited thereto.

When it is determined that the payment information is generated by the payment application control module 110, the fueling information providing module 120 checks whether the payment information includes fueling information. When the fueling information is included in the payment information, the fueling information providing module 120 may serve to extract the fueling information. Here, the fueling information may include a company name of the gas station, position information of the gas station, information on an amount of fueling, information on a price per liter, information on the entire cost of fueling and information on a payment card, and may include various pieces of information which may be extracted from an electronic receipt generated by the payment application when payment of fueling is performed.

The device interface supporting module 130 may serve to support transmit or receive various pieces of information to or from the service server 200 through the communication network 500. The device interface supporting module 130 may serve to transmit the fueling information extracted by the fueling information providing module 120 to the service server 200 through the communication network 500, may perform a process of searching the navigation device 400 within a certain radius and supporting to transmit or receive information to or from the navigation device 400. Further, when information on the recommended gas station is received from the service server 200 through the communication network 500, the device interface supporting module 130 may transfer the information on the recommended gas station to the navigation device 400 and support the navigation device 400 to output the information on the recommended gas station.

On the other hand, the user interface supporting module 140 may support the user input and support a process of outputting information for user recognition. For example, the user interface supporting module 140 may support user input of various pieces of information, and may support a process of outputting so that the user recognizes the recommended gas station transferred from the service server 200. Further, the user interface supporting module 140 may support user input and output of various pieces of information.

The detailed operation of the terminal 100 according to the embodiment of the present invention will be more clearly understood through a flowchart described below.

Hereinafter, a main configuration and operating method of the service server 200 according to the embodiment of the present invention will be described.

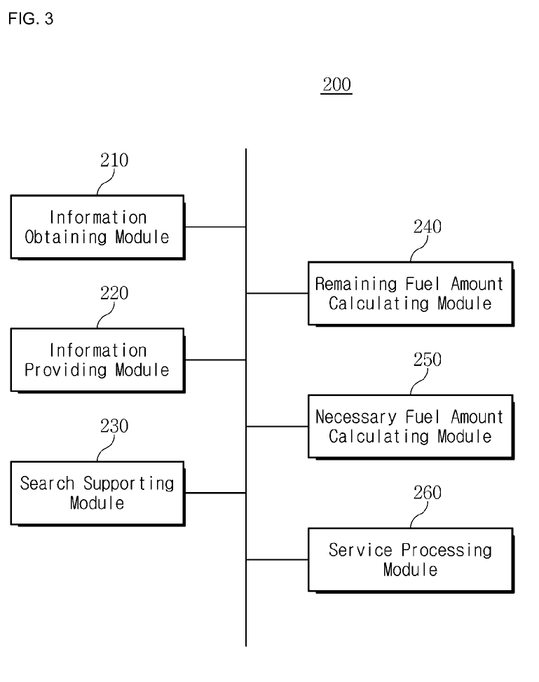

FIG. 3 is a block diagram illustrating a main configuration of a service server 200 according to an embodiment of the present invention.

Referring to FIGS. 1 and 3, the service server 200 according to the embodiment of the present invention may include an information obtaining module 210, an information providing module 220, a search supporting module 230, a remaining fuel amount calculating module 240, a necessary fuel amount calculating module 250, and a service processing module 260.

Here, a module is an element which performs a predetermined function, and may be implemented by hardware, software, or a combination of the hardware and the software. For example, the module may refer to a program module which includes elements such as software elements, object-oriented software elements, class elements and task elements, and processes, functions, attributes, procedures, subroutines, segments of program code, drivers, data, database, data structures, tables, arrays, and variables. Further, functions provided in the elements and “modules” may be coupled to a small number of elements and “modules”, or may be further divided into additional elements and “modules”.

To describe modules included in the service server 200 according to the embodiment of the present invention in more detail, first, the information obtaining module 210 may serve to obtain various pieces of information from the terminal 100 or the information providing server 300. For example, the information obtaining module 210 may support a process of obtaining vehicle information for the terminal 100 and information on the amount of remaining fuel. This process may be achieved according to input to the terminal 100. In other words, the terminal 100 may drive the payment application, and may perform inputting information on a vehicle to be applied to a main service and information on an amount of remaining fuel of the current vehicle, beforehand.

Then, when the terminal 100 receives the vehicle information from the user through a function of recommending a gas station supported by the payment application in the payment application, the terminal 100 transmits the vehicle information to the service server 200, and the information obtaining module 210 of the service server 200 may receive and obtain the information. Further, the vehicle information according to the embodiment may include information related to the vehicle, such as a vehicle type, fuel efficiency, a model, etc., and not limited to the above examples. Further, the information obtaining module 210 may receive and obtain destination information from the terminal 100, and information which may be registered and managed in the payment application, that is, payment-related information.

The information providing module 220 may provide various pieces of information generated when a recommendation service associated with the payment application according to the embodiment is used to the terminal 100. For example, the information providing module 220 may provide information on the recommended gas station to the terminal 100. In addition, the information providing module 220 may provide various pieces of information which may be generated when the service of the present invention is applied to the terminal 100.

The search supporting module 230 may serve to collect information related to gas stations. For example, when destination information is input by the terminal 100, the search supporting module 230 may collect various pieces of information related to the gas stations including information on gas stations located on a moving route from a current position to a destination and information on current gas prices at gas stations. At this time, the search supporting module 230 according to the embodiment of the present invention may collect various resources associated with the information providing server 300.

The remaining fuel amount calculating module 240 may serve to store and manage information on a current amount of remaining fuel in the car in which the terminal 100 is located. Particularly, the remaining fuel amount calculating module 240 according to the embodiment of the present invention may perform a process of continuously correcting the amount of remaining fuel to apply the embodiment of the present invention. In more detail, when information on the amount of remaining fuel, which was first input by the user through the information obtaining module 210, is delivered, the remaining fuel amount calculating module 240 stores the information. Then, the terminal 100 detects the case in which a vehicle moves without additional inputting of a destination in the navigation device 400 included in the vehicle. At this time, the terminal 100 may determine movement of the vehicle and a moving distance through a module, such as a GPS or the like included in the terminal 100, which may detect a location without additional inputting of information of a destination in the navigation device 400 included in the vehicle. Further, when the movement of the vehicle and the moving distance are determined, it may be determined that the vehicle moves only when a moving speed is higher than a certain value, and then the moving distance may be calculated. That is, the movement of the vehicle and the moving distance are determined while the case in which the user who has the terminal 100 moves on foot is distinguished from the case in which the user in the vehicle moves.

Then, when information on an amount of consumed fuel or information with which an amount of consumed fuel may be calculated are received, the remaining fuel amount calculating module 240 may correct the amount of remaining fuel in consideration of the information. Through this process, the service server 200 may calculate and manage more exactly the amount of remaining fuel using various resources included in the terminal 100 in consideration of a vehicle moving without inputting the destination information through the navigation device 400.

Further, the remaining fuel amount calculating module 240 according to the embodiment of the present invention may detect that fueling payment is performed in the terminal 100, and then may perform a process of continuously correcting the amount of remaining fuel. In other words, as described above, after a process of initial setting is performed, the terminal 100 uses the payment application to perform fueling payment, extracts the fueling information when the fueling payment is performed, and transfers the fueling information to the service server 200. Here, the fueling information may include a company name of

the gas station, position information of the gas station, information on an amount of fueling, information on a price per liter, information on the entire cost of fueling and information on a payment card. The terminal 100 transmits the fueling information generated by the payment application to the service server 200, and the service server 200 corrects the amount of remaining fuel using the fueling information. The service server 200 may correct the amount of remaining fuel using information on the amount of fueling included in the fueling information without consideration of a moving distance because there was not a vehicle movement while fueling is performed.

Through this process, the service server 200 according to the embodiment of the present invention may obtain more exact information on the current amount of fuel remaining in the user vehicle. The service server 200 may easily obtain and correct information on the amount of remaining fuel associated with the payment application even when there are no complicated hardware devices, such as a sensor, etc., or there is no frequent user input for calculating the amount of fuel.

Meanwhile, when the destination information is obtained by the information obtaining module, the necessary fuel amount calculating module 250 may calculate the amount of necessary fuel based on the destination information and the vehicle information which was obtained and stored beforehand. Here, the destination information may include current position information, information on a moving route calculated through a navigation function, and information on a moving distance, etc.

That is, the necessary fuel amount calculating module 250 may calculate the amount of fueling needed for moving from a current location to the destination based on the vehicle information, such as a vehicle type, fuel efficiency, and a model, etc., in consideration of the destination information. When the information on the moving distance is not included in the destination information, the necessary fuel amount calculating module 250 may further perform a process for calculating the moving distance from the current location to the destination.

Then, the service processing module 260 may compare the amount of remaining fuel managed by the remaining fuel amount calculating module 240 and the amount of necessary fuel calculated by the necessary fuel amount calculating module 250, and determine whether fueling is needed to move to the destination. As the result of the determination, when the fueling is needed, the service processing module 260 may check gas stations located on a moving route of the terminal 100 and extract information on an optimum gas station from information on the gas stations, and provide the information on the optimum gas station to the terminal 100. Particularly, the service processing module 260 according to the embodiment of the present invention may extract the information on the optimum gas station in overall consideration of not only gas prices but also information on the payment pattern of a vehicle driver and information on a preferred gas station.

To this end, the service processing module 260 may use payment-related information which includes information on a service membership card obtained beforehand in corresponding to the terminal 100. When the payment-related information is not up to date, the service processing module 260 may request the payment-related information in the terminal 100 and obtain it. Here, the payment-related information may include information on various service membership cards including a credit card and a check card registered through the payment application of the terminal 100, and a registered service membership card. Further, the payment-related information may include a usage pattern of a service membership card such as information on recent card use for a certain period.

When the above payment-related information is received, the service processing module 260 may extract information on a gas station located on a moving route on which the vehicle is driving based on the payment-related information. For example, when there are two gas stations A and B which have different brands from each other on a forward moving route of a vehicle which is currently moving, the service processing module 260 may check information on gas prices of each gas station located on a moving route through the information providing server 300, determine which of gas stations A and B is a gas station which has the cheapest gas price, and output the gas station which has the cheapest gas price. Even when the gas station A is cheaper than the gas station B, the service processing module 260 may apply a discount rate of a payment card included in the payment-related information received from the terminal 100. According to the result of this application, it may be determined that the gas station B is cheaper than the gas station A. Further, usage results of a plurality of cards used by the user of the terminal 100 may be checked. Even when the gas station B is cheaper than the gas station A, when more service usages are available in the gas station A, for example, when the card of a special brand is used in the gas station A, then a usage result or a grade goes up, the service processing module 260 may determine whether the use of the specific card in the gas station A is better than getting a discount on a gas price in the gas station B, and provide the result of the determination. That is, in extracting information on the gas station having the lowest gas price from information on gas stations located on a moving route of a vehicle, the service server 200 extracts information on the gas station having the lowest gas price not simply by comparing gas prices, but by overall consideration of the payment-related information including card brands, usage results of cards, and usage patterns associated with the payment application of the terminal 100, and then provides the extracted information to the terminal 100.

Then, the service processing module 260 may transfer the extracted information on the recommended gas station to the information providing module 220, and the information providing module 220 may transmit the information to the terminal 100.

The detailed operation of the service server 200 according to the embodiment of the present invention will be more clearly understood through flowcharts described below.

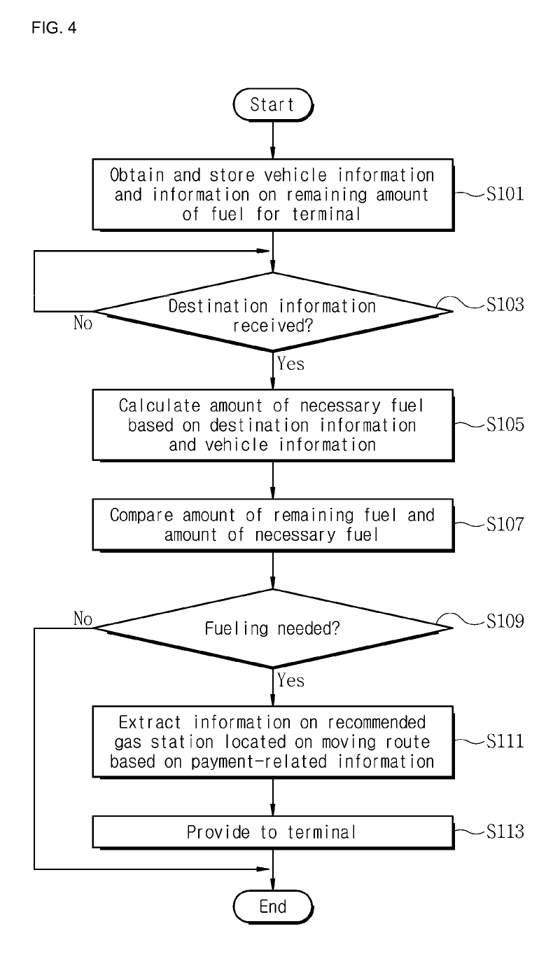

Hereinafter, the method of recommending a gas station associated with a payment application according to the embodiment of the present invention will be described with reference to FIGS. 4 to 7.

FIG. 4 is a flowchart illustrating a method of recommending a gas station associated with a payment application according to an embodiment of the present invention.

Referring to FIGS. 1 and 4, the method of recommending a gas station associated with a payment application according to the embodiment of the present invention may first start operating the service server 200 to obtain and store vehicle information and information on an amount of remaining fuel for the terminal 100 (S101).

Then, when destination information is received from the terminal 100 (S103), the service server 200 calculates an amount of necessary fuel based on the destination information and the vehicle information (S105). That is, because the information on the amount of remaining fuel of the current vehicle is received beforehand in operation S101, the service server 200 may calculate the amount of fueling needed for moving from a current location to the destination based on the vehicle information, such as a vehicle type, fuel efficiency and a model, etc., in consideration of the destination information, and may compare the amount of remaining fuel and the amount of necessary fuel (S105 and S107).

Then, when it is determined that fueling is needed (S109), the service server 200 may extract information on a recommended gas station located on a moving route to the destination based on the payment-related information (S111), and may provide the extracted information on recommended gas station to the terminal (S113).

Hereinafter, the process described above will be described in more detail.

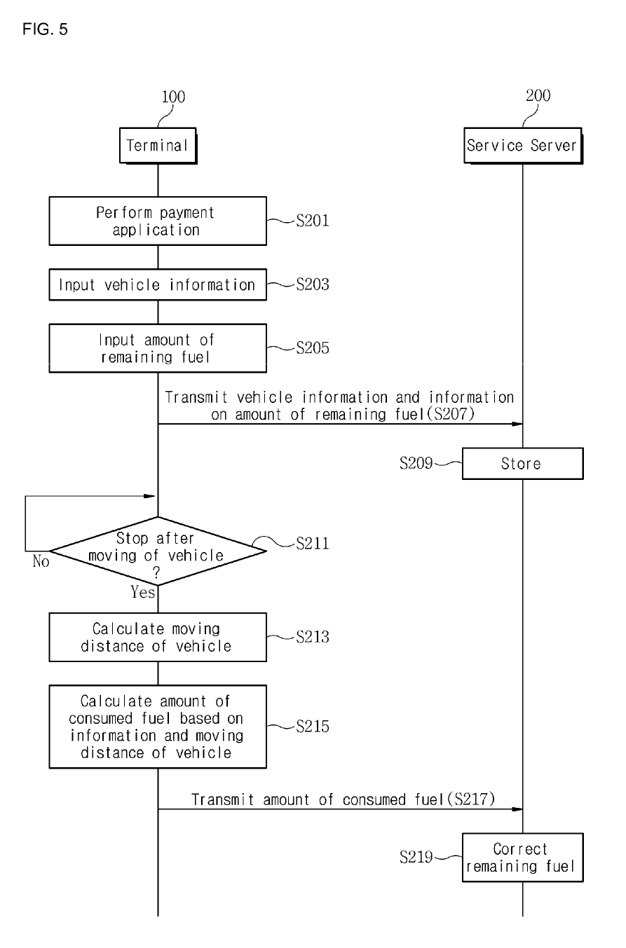

FIGS. 5 to 7 are data flowcharts illustrating a method of recommending a gas station associated with a payment application according to an embodiment of the present invention in more detail.

First, referring to FIG. 5, the greatest feature of the present invention is recommending a gas station associated with a payment application set in the terminal 100. Therefore, in the terminal 100, a process of inputting information on a vehicle applied to this service and information on current amount of remaining fuel of the vehicle, beforehand, is needed.

To this end, the terminal 100 executes the payment application (S201). Here, the payment application refers to an application which may be downloaded beforehand from the service server 200 or a separate application providing device and be installed in the terminal 100. The method of recommending a gas station associated with a payment application according to the embodiment of the present invention may be implemented through a function in the payment application. Further, the method may be implemented through an independent application which may be associated with the payment application. Hereinafter, the present invention will be described assuming that the method is implemented through a function in the payment application for convenience of description, but it should be noted that the present invention is not be limited thereto.

Then, the terminal 100 receives the vehicle information from the user through a function of recommending a gas station supported by the payment application in the payment application (S203). Here, the vehicle information according to the embodiment may include information related to the vehicle, such as a vehicle type, fuel efficiency, a model, etc., and not limited to the above examples. Then, the terminal 100 supports user input of an amount of remaining fuel (S205). Here, the process of inputting the amount of remaining fuel by the user may include user input once in a process of an initial setup process. When it is determined that re-input of the amount of remaining fuel is needed, the terminal 100 may support the user input of the amount of remaining fuel.

After the above process, when the inputting of information on the vehicle and the amount of remaining fuel is completed, the terminal 100 transmits the information to the service server 200 (S207), the service server 200 may store the information on the vehicle and the amount of remaining fuel corresponding to identification information on the terminal 100 (S209). Further, it is obvious that the identification information, such as a terminal device number, etc., may be transmitted or received when information is transmitted or received between the terminal 100 and the service server 200.

After the above process, the process of initial input of information for the recommendation of a gas station by the terminal 100 may be completed. In this state, the terminal 100 detects whether a vehicle moves (S211). Here, the terminal 100 detects the case in which a vehicle moves without additional inputting of a destination in the navigation device 400 included in the vehicle. At this time, the terminal 100 may determine movement of the vehicle and a moving distance through a module, such as a GPS included in the terminal 100, which may detect a location without additional inputting of information on a destination in the navigation device 400 included in the vehicle. Further, when the movement of the vehicle and the moving distance are determined, it may be determined that the vehicle moves only when a moving speed is higher than a certain value and the moving distance may be calculated (S213). That is, the movement of the vehicle and the moving distance are determined while the case in which the user who has the terminal 100 moves on foot is distinguished from the case in which the user in the vehicle moves.

Then, the terminal 100 calculates an amount of consumed fuel (S215) which is consumed while the vehicle moves based on the vehicle information input in operation S203 and the moving distance of the vehicle calculated in operation S213. Then, when the amount of consumed fuel is calculated, the terminal 100 transfers information on the amount of consumed fuel to the service server 200 (S217), the service server 200 corrects the amount of remaining fuel (S219) in consideration of the amount of consumed fuel. Further, when movement of a vehicle is detected without performing operation S215, the terminal 100 calculates a moving distance of a vehicle, and transfers information on the moving distance of the vehicle to the service server 200. The service server 200 may calculate the amount of consumed fuel, and may subtract the amount of consumed fuel from the amount of remaining fuel to correct the amount of remaining fuel in response to the terminal 100. Through the above process, the service server 200 may calculate and manage more exactly the amount of remaining fuel using various resources included in the terminal 100 in consideration of a vehicle moving without inputting the destination information through the navigation device 400.

Then, the service server 200 may detect that fueling payment is performed in the terminal 100, and then may perform a process of continuously correcting the amount of remaining fuel.

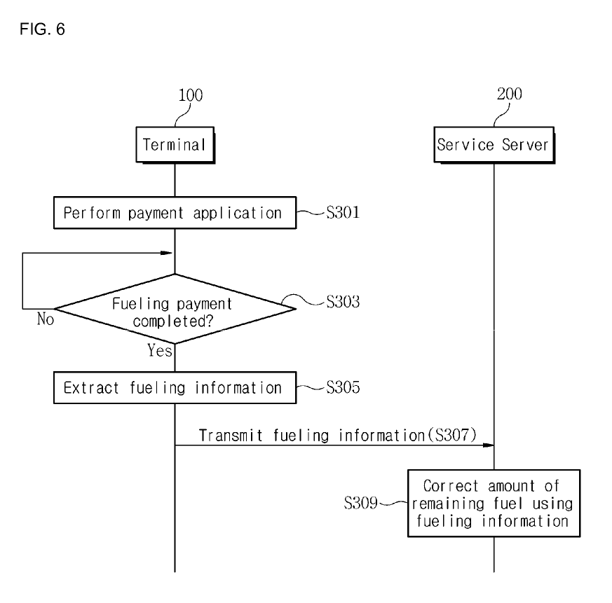

Referring to FIG. 6, the terminal 100 may perform the process of the initial setup as shown in FIG. 5, then may use the payment application to perform fueling payment (S301), and may extract fueling information (S303 and S305) when the fueling payment is completed.

Here, the fueling information may include a company name of the gas station, position information of the gas station, information on an amount of fueling, information on a price per liter, information on the entire cost of fueling and information on a payment card. The terminal 100 transmits the fueling information generated by the payment application to the service server 200, and the service server 200 corrects the amount of remaining fuel using the fueling information (S309). The service server 200 may correct the amount of remaining fuel using information on the amount of fueling included in the fueling information without consideration of a moving distance because there was not vehicle movement while fueling is performed.

Through this process, the service server 200 may obtain more exact information on the current amount of fuel remaining in the user vehicle. The service server 200 may easily obtain and correct the amount of remaining fuel associated with the payment application even when there are no complicated hardware devices, such as a sensor, etc., or there is no frequent user input for calculating the amount of fuel.

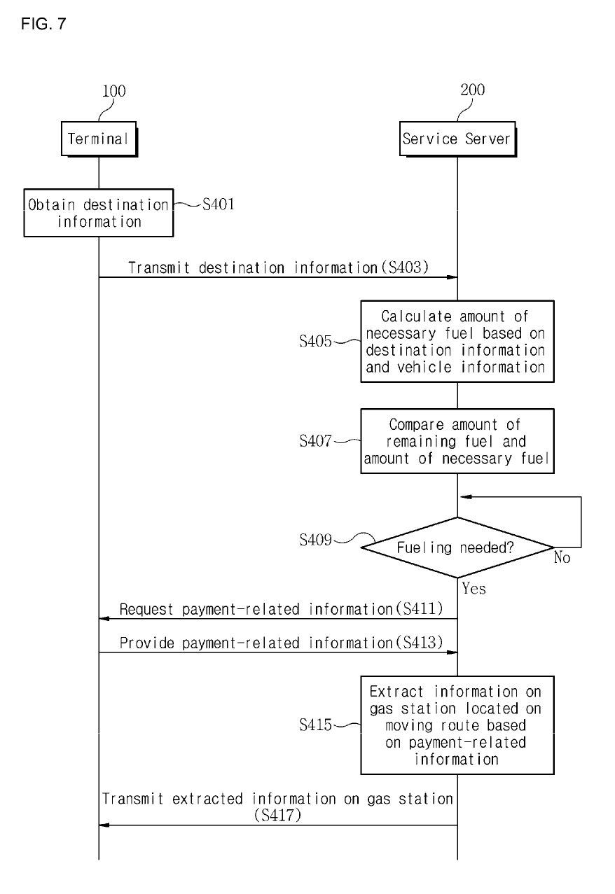

Hereinafter, a process of calculating the amount of remaining fuel when the vehicle is moving, searching for a gas station having the lowest gas price, and recommending and providing the gas station having the lowest gas price will be described with reference to FIG. 7.

Referring to FIG. 7, the terminal 100 obtains the destination information (S401). Here, the destination information may be received and obtained from the navigation device 400. On the contrary, when the terminal 100 has a navigation function itself and the user inputs the destination information through the navigation function included in the terminal 100, the terminal 100 may detect the user input and obtain the destination information. Further, the destination information may include information on a current location, information on a location of the destination input by the user, information on a moving route calculated through the navigation function, and information on the moving route.

The service server 200 calculates an amount of fuel needed to move to the location of destination based on information on the moving distance of destination information and vehicle information, such as fuel efficiency, a model, etc., which is stored beforehand in response to the control of the terminal (S405). In the above process, when the information on a moving distance is not included in the destination information, the service server 200 may further perform a process of calculating the moving distance from the current location to the destination.

Then, the service server 200 may compare the calculated amount of necessary fuel and the amount of remaining fuel obtained beforehand in response to the control of the terminal 100, and determine whether fueling is needed to move to the destination. As the result of the determination, when the fueling is needed, the service server 200 may check gas stations located on a moving route of the terminal 100 and extract information on an optimum gas station from the gas stations, and provide the information on the optimum gas station to the terminal 100. Particularly, the service server 200 according to the embodiment of the present invention may extract the information on the optimum gas station in overall consideration of not only gas prices but also information on the payment pattern of a vehicle driver and information on a preferred gas station.

To this end, the service server 200 may use payment-related information obtained beforehand in response to the control of the terminal 100. When there is no payment-related information or when the payment-related information is not up to date, the service server 200 may request the payment-related information in the terminal 100 and obtain it (S411 and S413). Here, the payment-related information may include information on various payment cards including a credit card, a check card, and the like registered through the payment application of the terminal 100, and a registered service membership card. Further, the payment-related information may include information on recent card use for a certain period.

The service server 200 may extract information on a gas station located on a moving route on which a vehicle is driving based on the payment-related information (S415). For example, when there are two gas stations A and B which have different brands from each other on a forward moving route of a vehicle which is currently moving, the service server 200 may check information on gas prices of each gas station located on a moving route through the information providing server 300, determine which of A and B is a gas station which has the cheapest gas price, and output the gas station which has the cheapest gas price. Even when the gas station A is cheaper than the gas station B, the service server 200 may apply a discount rate of a payment card included in the payment-related information received from the terminal 100. According to the result of application, it may be determined that the gas station B is cheaper than the gas station A. Further, usage results of a plurality of cards used by the user of the terminal 100 may be checked. Even when the gas station B is cheaper than the gas station A, when more service usages are available in the gas station A, for example, when the card of a special brand is used in the gas station A, then a usage result or a grade goes up, the service server 200 may determine whether the use of the specific card in the gas station A is better than getting a discount on a gas price in the gas station B, and provide the result of the information.

That is, in extracting information on the gas station having the lowest gas price from information on gas stations located on a moving route of a vehicle, the service server 200 extracts information on the gas station having the lowest gas price not simply by comparing gas prices, but by overall consideration of the payment-related information including card brands, usage results of cards and usage patterns associated with the payment application of the terminal 100, and then provides the extracted information on the gas station to the terminal 100.

Further, in operation S415, when there is no gas station which provides a service benefit according to information on the service membership card of the terminal 100 among gas stations located on the moving route, the service server 200 may extract information on a recommended gas station from information on gas stations located within a certain radius of the moving route, and correct the moving route to move to the recommended gas station, and provide information on the recommended gas station to the terminal 100.

Further, the service server 200 provides information on the recommended gas station to the terminal 100, and then when the fueling information is not received through the payment application of the terminal 100, the service server 200 may provide messages for inputting the amount of remaining fuel to the terminal 100 and may receive information on the amount of remaining fuel input by the user from the terminal 100, because information on the amount of remaining fuel may be changed or some errors may have occurred.

As described above, according to the embodiment of the present invention, it may be determined more exactly when the fueling is needed, and information on the amount of fuel associated with the payment application may be checked more easily even when a separate device for checking the amount of fuel is not included.

Further, according to the embodiment of the present invention, a customized gas station recommendation can be provided in consideration of a life pattern of a user by recommending an optimum gas station in consideration of payment-related information including usage results and benefits of user cards registered in the payment application.

In the above, the method of recommending a gas station associated with a payment application has been described.

The method of recommending a gas station associated with a payment application as described above may be provided in a form of medium readable by the computer suitable for storing computer program commands and data. The program, which is written in the computer-readable medium, for implementing the method of recommending a gas station associated with a payment application according to one embodiment of the present invention may operate a service server for receiving a destination information from a terminal, calculating an amount of necessary fuel based on the destination information and vehicle information for the terminal, comparing an amount of remaining fuel for the terminal and the calculated amount of necessary fuel to determine whether fueling is needed, when the fueling is needed, extracting information on a recommended gas station from information on gas stations located on a moving route to a destination based on payment-related information for the terminal, and providing the extracted information on the recommended gas station to the terminal.

The program written in the computer-readable medium may be read, set, and executed by the computer so that above-described functions are performed.

Here, the above-mentioned program may include a code coded by a computer language, such as C, C++, JAVA, a machine language, etc., the code being readable by the central processing unit (CPU) through an interface of the computer, so that the computer reads the program written in the computer-readable medium and executes functions performed by the program.

The code may include a function code related to a function which defines the above-described functions, or a control code related to an execution procedure required for a computer processor to execute the above-described functions in a predetermined order. Further, the code may further include additional information required for a computer processor to execute the above-described functions, or may include a code related to a memory reference, that is, at which a location of internal memory or external memory media should be referenced. Further, when the computer is required to communicate with another computer or a server in a remote area to execute the above-described functions, the code may include a communication-related code, which is about how the computer should communicate with the other computer or the server in a remote area, or what information or media the computer processor should transmit or receive.

The computer-readable medium suitable for writing computer program commands and data may include magnetic media such as a hard disk, a floppy disk and a magnetic tape, optical media such as a compact disk read only memory (CD-ROM) and a digital video disk (DVD), magneto-optical media such as a floptical disk, and a semiconductor memory such as a read only memory (ROM), a random access memory (RAM), a flash memory, an erasable programmable ROM (EPROM), and an electrically erasable programmable ROM. The processor and the memory may be supplemented by a special purpose logic circuit or may be integrated into the special purpose logic circuit.

Further, the computer-readable medium may be distributed to computer systems connected by a network, and the code readable by the computer may be written in a distributed mode. Further, functional program for implementing the present invention, code related to the functional program, and code segments may be easily deduced or changed by the programmers skilled in the art in consideration of a computer system environment in which a program is executed after reading the computer-readable medium.

Each operation according to the embodiment of the present invention may be implemented with commands which can be executed by a computer, and executed by a computing system. Here, “computing system” may be defined by at least one software module, at least one hardware module, or combinations thereof. For example, the computer system may include a software module such as an operating system of a personal computer and a hardware component of the personal computer. The physical layout of the module is not important. The computer system may include at least one computer connected through a network.

Similarly, the computing system may be implemented by at least one physical device such as a memory and a processor, which operate while internal modules perform an operation on electronic data.

That is, the device for the method of recommending a gas station associated with a payment application according to the embodiment of the present invention may be implemented to perform the above-described embodiments based on the computing system.

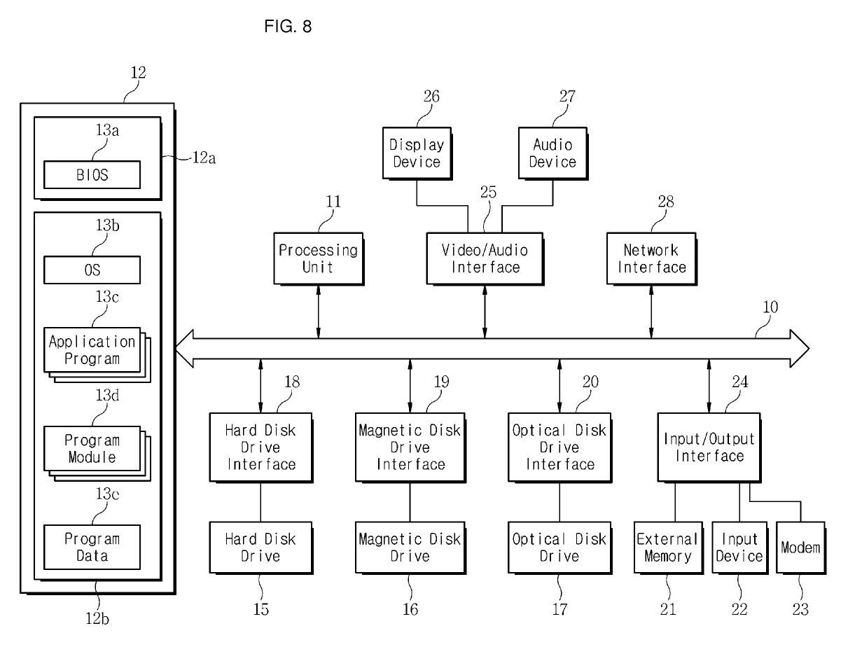

FIG. 8 is a block diagram illustrating a computing system which implements the method of recommending a gas station associated with a payment application according to embodiments of the present invention.

Hereinafter, a simple and general description of a computing environment suitable for implementing the embodiment of the present invention will be provided. The present invention may be described in relation to computer-executable commands such as a program module executed by the computer system. In general, the program module may include a routine, a program, an object, a component, a data structure, and/or the like which implement a special task or a particular abstract data format. The computer-executable commands, the data structure, and the program module represent examples of a program code method which implements the invention disclosed in this specification.

Referring to FIG. 8, the exemplary computing system which implements embodiments of the present invention may include a computing device which includes a processing unit 11, a system memory 12, and a system bus 10 which connects various system components including the system memory 12 to the processing unit 11.

The processing unit 11 may execute the computer-executable commands which implement the features of the present invention.

The system bus 10 may be any of several types of bus structures including a memory bus or memory controller, a peripheral bus, and a local bus using any of a variety of bus architectures. The system memory 12 may include a ROM 12a and a RAM 12b. A basic input/output system (BIOS) 13a including a basic routine which supports transmission of information between elements in the computing system during operation may be generally stored in ROM 12a.

The computing system may include a storage device which includes a hard disk drive 15 which reads information from a hard disk or writes information to the hard disk, a magnetic disk drive 16 which reads information from a magnetic disk or writes information to the magnetic disk, and an optical disk drive 17 which reads information from an optical disk such as CD-ROM or other optical media or writes information to the optical disk. The hard disk drive 15, the magnetic disk drive 16 and the optical disk drive 17 may be connected to the system bus 10 through a hard disk drive interface 18, a magnetic disk drive interface 19 and an optical disk drive interface 20, respectively.

Further, the computing system may include an external memory 21 as the storage device. The external memory 21 may be connected to the system bus 10 through an input/output interface 24.

The above-described drives and the related computer-readable media read and recorded by the drives may provide non-volatile storage of computer-executable commands, data structures, program modules and other data. Although the exemplary environment described in this specification illustrates the hard disk drive 15, the magnetic disk drive 16 and the optical disk drive 17, the environment may include other types of computer-readable media including a magnetic cassette, a flash memory card, DVD, a Bernoulli cartridge, RAM, ROM, etc., which store data

A program code means including at least one program module which includes the operating system 13b, at least one application program 13c, other program modules 13d and program data 13e may be stored in the hard disk drive 15, the magnetic disk drive 16, the optical disk drive 17, ROM 12a and RAM 12b.

Further, the computing system may receive commands and information from the user through other input devices 22 including a keyboard, a joy stick, a game pad and a scanner. These input devices 22 may be connected to the processing unit 11 through the input/output interface 24 connected to the system bus 10. For example, the input/output interface 24, for example, may logically represent any one of various different interfaces including a serial port interface, a PS/2 interface, a parallel port interface, USB interface and IEEE 1394 interface which is a FireWire interface. The input/output interface 24 may logically represent a combination of other interfaces.

Further, the computing system in which the present invention is applied may further include a display device 26 such as a monitor or LCD, and an audio device 27 such as a speaker or a microphone, and these may be connected to the system bus 10 through a video/audio interface 25. For example, other peripheral output devices such as the speaker and a printer (not shown) may be further connected to the computing system. The video/audio interface 25 may include a High Definition Multimedia Interface (HDMI), a Graphics Device Interface (GDI), etc.

Further, the computing system which performs the present invention, for example, may be connected to a network such as an office-wide or company-wide computer network, a home network, an intranet, and/or the Internet. The computer system may exchange data with external sources including a remote computer system, a remote application, and/or a remote data base through these networks.

To this end, the computing system in which the present invention is applied may include a network interface 28 which receives data from an external source and/or transmits data to the external source.

In the present invention, the computing system may transmit or receive information with a device located in a remote site through the network interface 28. For example, when the computing system denotes the terminal 100, the terminal 100 may transmit or receive information to or from the service server 200 through the network interface 28. On the contrary, when the computing system denotes the service server 200, the service server 200 may transmit or receive information to or from the terminal 100 through the network interface 28. The network interface 28, for example, may be expressed as a logical combination of at least one software module and/or hardware module, such as a network interface card and a corresponding Network Driver Interface Specification (NDIS) stack.

Similarly, the computing system may receive data from an external source and/or transmit data to the external source through the input/output interface 24.

The input/output interface 24 may be connected to a modem 23, for example, a standard modem, a cable modem, or a digital subscriber line (DSL) modem, and may receive data from an external source and/or transmit data to the external source through the modem 23.

While FIG. 8 illustrates a suitable operating environment, the principles of the present invention, with proper modification if needed, may be applied to an arbitrary system in which the principle of the present invention can be implemented. The environment illustrated in FIG. 8 is simply exemplary, and does not illustrate even a little portion of various environments in which the principle of the present invention can be implemented.

Further, various pieces of information generated in relation to a gas station recommending system associated with a payment application of the present invention may be stored in an arbitrary computer-readable medium related to the computing system of FIG. 8 and may be accessed. For example, a portion of the program module and a portion of related program data may be included in the operating system 13b, the application programs 13c, the program modules 13d, and/or the program data 13e, to store in the system memory 12.

Further, when a mass storage device, such as a hard disk, is connected to the computing system, the program modules and the related program data may be stored in the mass storage device. In a network environment, the program module or a portion of the program module may be stored in a remote memory storage device such as a system memory and/or a mass storage device related to a remote computer system, for example, a computing system of a user terminal 100 and a computing system of a franchise's terminal 200, connected through the modem 23 of input/output interface 24 or the network interface 28. The execution of the module may be performed in a distributed environment, as the described above.

The specification includes details of a number of specific implementations, but it should be understood that the details do not limit any invention or what is claimable in the specification but rather describe features of the specific embodiments. Features described in the specification in the context of individual embodiments may be implemented as a combination in a single embodiment. In contrast, features described in the specification in the context of a single embodiment may be implemented in multiple embodiments individually or in an appropriate sub-combination. Furthermore, the features may operate in a certain combination and may be initially described as claimed in the combination, but one or more features may be excluded from the claimed combination in some cases, and the claimed combination may be changed into a sub-combination or a modification of a sub-combination.

Similarly, even though operations are described in a certain order in the drawings, it should not be understood that the operations be executed in the certain order or in a sequential order to obtain a desired result, or that all the operations be executed. In some cases, multitasking and parallel processing may be beneficial. In addition, it should not be understood that the separation of various system components in the above described embodiments is required in all embodiments, and it should be understood that the above described program components and systems may be incorporated into a single software product or may be packaged in multiple software products.

Thus, particular embodiments have been described. Other embodiments are within the scope of the following claims. For example, the operations recited in the claims can be performed in a different order and still achieve desirable results. As an example, operations depicted in the drawings in a particular order should not be understood as requiring that such operations be performed in the particular order shown or in sequential order. In a certain embodiment, multitasking and parallel processing may be beneficial.

This written description sets forth the best mode of the invention and provides examples to describe the invention and to enable a person of ordinary skill in the art to make and use the invention. The specification drafted as such is not limited to detailed terms suggested in the specification. Accordingly, it will be apparent to those skilled in the art that various modifications, changes, and variations may be made in the example without departing from the scope of the invention.

Accordingly, the scope of the present invention should be defined not by the embodiments but by the appended claims.

The present invention relates to a method of recommending a gas station, and more particularly, to a method of recommending a gas station associated with a payment application, which is able to manage information on the current amount of fuel in the vehicle, recommend an optimum gas station associated with the payment application when it is determined that fueling is needed, and guide a user to the optimum gas station, and a device using the method.

Referring to embodiments of the present invention, the method of recommending a gas station associated with a payment application may determine more exactly when the fueling is needed, and may more easily check information on the amount of fuel associated with the payment application even when a separate device for checking the amount of fuel is not included. Therefore, the present invention can contribute to the development of a service industry.

Further, the present invention has an industrial applicability because it has not only sufficient possibilities of sales and business but also has a practical implementation.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A method of recommending a gas station associated with a payment application, the method comprising:
receiving, by a service server, destination information from a terminal;
calculating, by the service server, an amount of necessary fuel based on the destination information and vehicle information for the terminal;
comparing, by the service server, an amount of remaining fuel for the terminal and the calculated amount of necessary fuel to determine whether fueling is needed;
when the fueling is needed, extracting, by the service server, information on a recommended gas station from information on gas stations located on a moving route to a destination based on payment-related information for the terminal; and
providing, by the service server, the extracted information on the recommended gas station to the terminal.

2. The method of claim 1, further comprising receiving and storing, by the service server, the vehicle information and information on the amount of remaining fuel from the terminal, before receiving the destination information,

3. The method of claim 2, further comprising:
after storing the vehicle information and the information on the amount of remaining fuel,
receiving, by the service server, information on an amount of fuel to be consumed based on a moving distance from start to stop from the terminal; and
correcting, by the service server, the amount of remaining fuel based on the information on the amount of fuel to be consumed.

4. The method of claim 2, further comprising:
after storing the vehicle information and the information on the amount of remaining fuel,
receiving, by the service server, fueling information generated after fueling payment using the payment application from the terminal; and
correcting the amount of remaining fuel based on the fueling information.

5. The method of claim 1, wherein the extracting of the information on the recommended gas station comprises:
requesting, by the service server, the payment application of the terminal for payment-related information including information on a service membership card of the terminal to obtain the payment-related information; and
after checking, by the service server, the information on a service membership card of the terminal, extracting information on a gas station having a highest discount rate from information on gas stations located on the moving route based on the information on the service membership card of the terminal as the recommended gas station, or extracting information on a certain gas station as information on the recommended gas station in consideration of a usage pattern of the service membership card of the terminal by the service server.

6. The method of claim 5, further comprising:
when a gas station which provides a service benefit based on the information on the service membership card of the terminal does not exist among gas stations located on the moving route, extracting, by the service server, information on the recommended gas station from information on gas stations located within a certain radius of the moving route; and
correcting, by the service server, the moving route to move to the recommended gas station, and guiding the terminal thereto.

7. The method of claim 1, further comprising exhibiting, by the service server, a message for inputting the amount of remaining fuel to the terminal when fueling information is not received through the payment application from the terminal, after providing the extracted information on the recommended gas station,

8. A computer-readable medium, wherein a program which executes a method of recommending a gas station associated with a payment application, the method comprising:
receiving, by a service server, destination information from a terminal;
calculating, by the service server, an amount of necessary fuel based on the destination information and vehicle information for the terminal;
comparing, by the service server, an amount of remaining fuel for the terminal and the calculated amount of necessary fuel to determine whether fueling is needed;
when the fueling is needed, extracting, by the service server, information on a recommended gas station from information on gas stations located on a moving route to a destination based on payment-related information for the terminal; and
providing, by the service server, the extracted information on the recommended gas station to the terminal.

9. A service server comprising:
an information obtaining module configured to receive and obtain destination information, vehicle information and information on an amount of remaining fuel from a terminal;
a remaining fuel amount calculating module configured to correct and calculate the amount of remaining fuel based on fueling information generated by a payment application of the terminal;
a necessary fuel amount calculating module configured to calculate the amount of necessary fuel based on the destination information and the vehicle information; and
a service processing module configured to compare the amount of remaining fuel for the terminal and the calculated amount of necessary fuel to determine whether fueling is needed, and when the fueling is needed, configured to extract information on a recommended gas station from information on gas stations located on a moving route to a destination based on payment-related information for the terminal.

10. The service server of claim 9, further comprising a search supporting module configured to transmit information on the recommended gas station to the terminal.
